(19) United States
(12) Patent Application Publication
(10) Pub. No.: US 2019/0004727 A1
(43) Pub. Date: Jan. 3, 2019

(54) USING A NAMESPACE TO AUGMENT DE-DUPLICATION

(71) Applicant: International Business Machines Corporation, Armonk, NY (US)

(72) Inventors: Ilya Volvovski, Chicago, IL (US); S. Christopher Gladwin, Chicago, IL (US); Gary W. Grube, Barrington Hills, IL (US); Timothy W. Markison, Mesa, AZ (US); Jason K. Resch, Chicago, IL (US); Thomas F. Shirley, JR., Wauwatosa, WI (US); Greg R. Dhuse, Chicago, IL (US); Manish Motwani, Chicago, IL (US); Andrew D. Baptist, Mt. Pleasant, WI (US); Wesley B. Leggette, Chicago, IL (US)

(21) Appl. No.: 16/124,789

(22) Filed: Sep. 7, 2018

Related U.S. Application Data
(63) Continuation-in-part of application No. 14/172,140, filed on Feb. 4, 2014, now Pat. No. 10,075,523.
(60) Provisional application No. 61/807,288, filed on Apr. 1, 2013.

(51) Int. Cl. G06F 3/06; G06F 17/30; G06F 11/10

(52) U.S. Cl. CPC G06F 3/0641; G06F 17/30303; G06F 3/067; G06F 11/1076; G06F 3/0608; G06F 17/30371

(57) ABSTRACT

Data to be de-duplicated for storage in a DSN memory is received. A source name is generated and associated with the data. The source name is generated based on contents of the data to be stored. Encoded data slices are generated from the data, and slice names are assigned based on the source name associated with the data being encoded. Distributed storage (DS) units are selected based on the slice names of the encoded data slices, and are assigned to de-duplicate and store the encoded data slices. The encoded data slices are transmitted to the selected DS units for de-duplication and storage of de-duplicated encoded data slices.

### CROSS-REFERENCE TO RELATED APPLICATIONS

This application claims priority pursuant to 35 U.S.C. § 120 as a continuation-in-part of U.S. Utility application Ser. No. 14/172,140, entitled “EFFICIENT STORAGE OF DATA IN A DISPERSED STORAGE NETWORK”, filed Feb. 4, 2014, scheduled to issue as U.S. Pat. No. 10,075,523 on Sep. 11, 2018, which claims priority pursuant to 35 U.S.C. § 119(e) to U.S. Provisional Application No. 61/807,288, entitled “DE-DUPLICATING DATA STORED IN A DISPERSED STORAGE NETWORK”, filed Apr. 1, 2013, now expired, all of which are hereby incorporated herein by reference in their entirety and made part of the present U.S. Utility patent application for all purposes.

### BACKGROUND

This invention relates generally to computer networks and more particularly to dispersing error encoded data.

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

Many conventional storage systems can de-duplicate data to improve the utilization of storage resources. However, currently available de-duplication technologies may not be fully effective in systems that store data in a distributed fashion.

### SUMMARY

According to an embodiment of the present invention, a distributed storage network (DSN) includes a processor and associated memory used to implement a distributed storage (DS) processing module, and a DSN memory coupled to the DS processing module. The DSN memory includes multiple DS units, and a processor with associated memory.

The DS processing module receives data to be de-duplicated for storage in the DSN memory, and generates a source name associated with the data. The source name is generated based on contents of the data to be stored, such that two different instances of identical data will be assigned a substantially similar source name. The DS processing module generates encoded data slices from the data, and assigns slice names to the encoded data slices based on the source name associated with the data being encoded. In some embodiments, each slice name includes a corresponding pillar index field entry, the source name, and a segment number.

The DS processing module selects DS units based on the slice names of the encoded data slices, and assigns the selected DS units to de-duplicate and store the encoded data slices. The DS processing module transmits the encoded data slices to the selected DS units for de-duplication and storage of de-duplicated encoded data slices. A data of the data can be associated with the source name, for example using an index or directory.

In various embodiments, the data is segmented to produce multiple data segments, and each of the plurality of data segments is encoded to generate a set of encoded data slices. At least a read-threshold number of encoded data slices included in the set of encoded data slices can be required to reconstruct the data.

In at least one embodiment, a selected DS unit receives a write slice request of the set of write slice requests including a first encoded data slice and a slice name, and determines whether the first encoded data slice is a duplicate of a second encoded data slice already stored by the selected DS unit. In response to determining that the first encoded data slice is not a duplicate of a second encoded data slice already stored by the selected DS unit, the DSN memory stores the first encoded data slice in the selected DS unit.

All or part of the various embodiments can be implemented as a method, a distributed storage network (DSN), as a DS processing module, or a DSN memory.

### BRIEF DESCRIPTION OF THE DRAWINGS

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an embodiment of a dispersed storage system in accordance with the present invention;

FIG. 10 is a flowchart illustrating an example of storing data in accordance with the present invention; and

FIG. 11 is a flowchart illustrating another example of storing data in accordance with the present invention.

### DETAILED DESCRIPTION

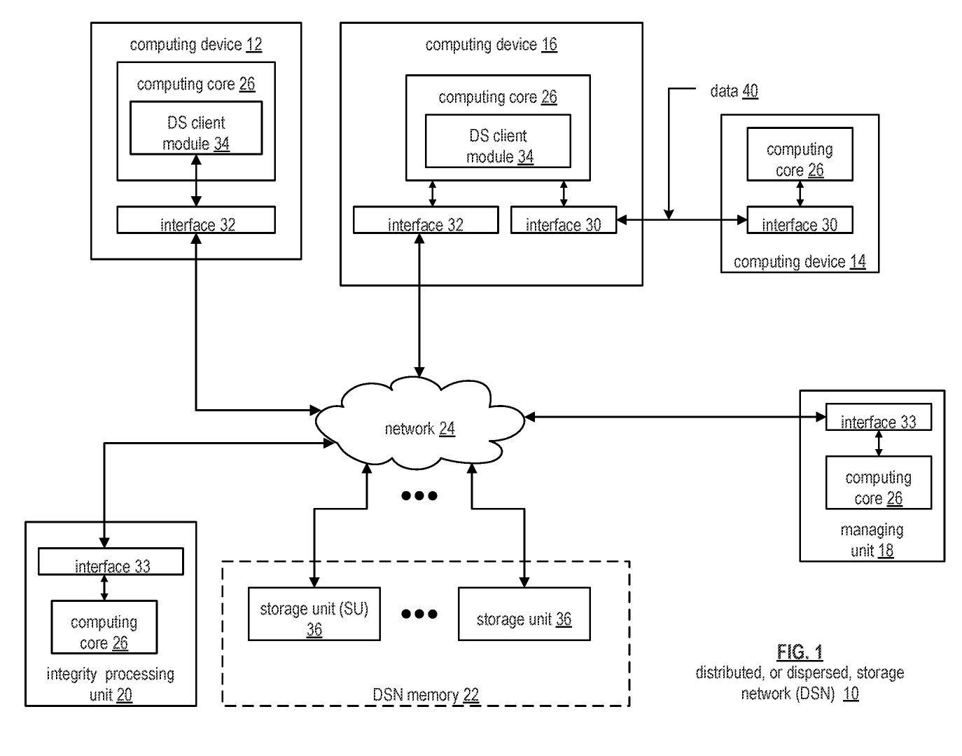

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

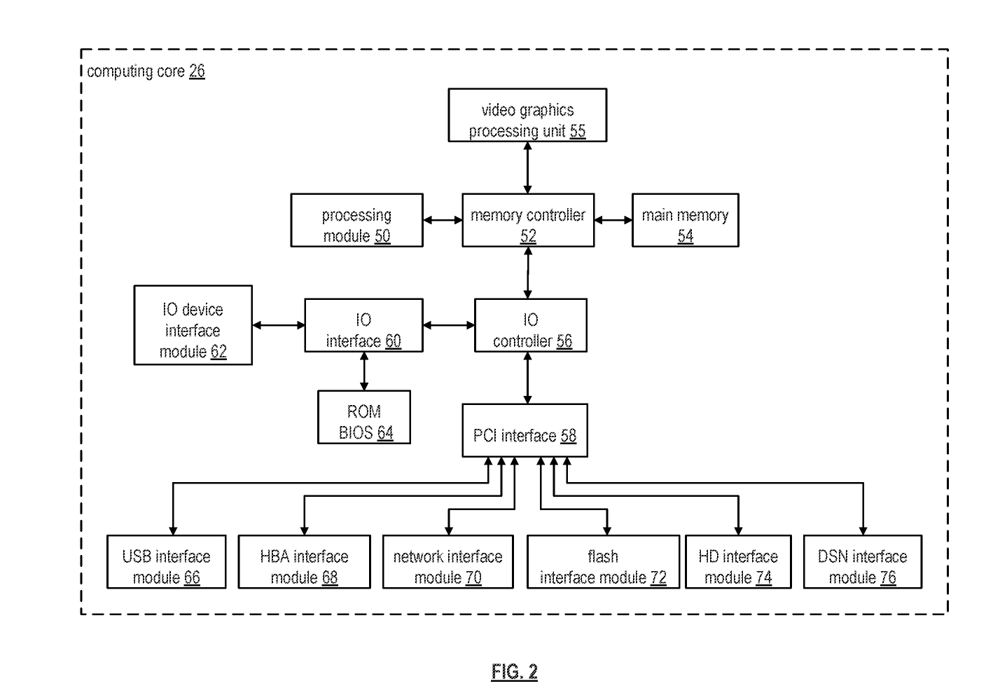

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

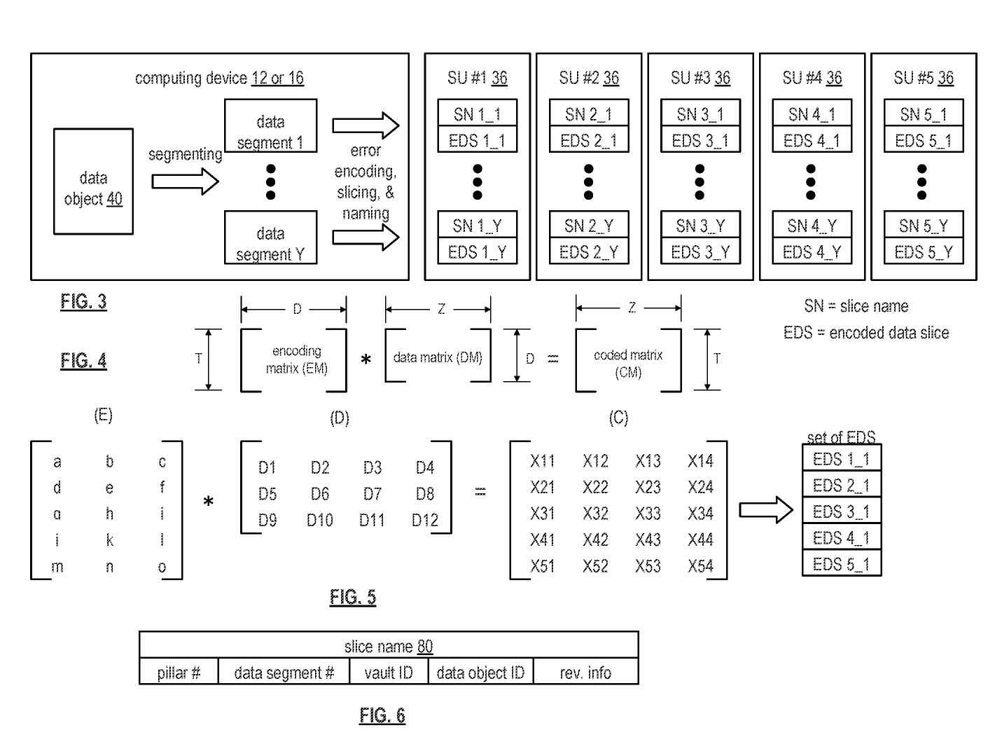

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

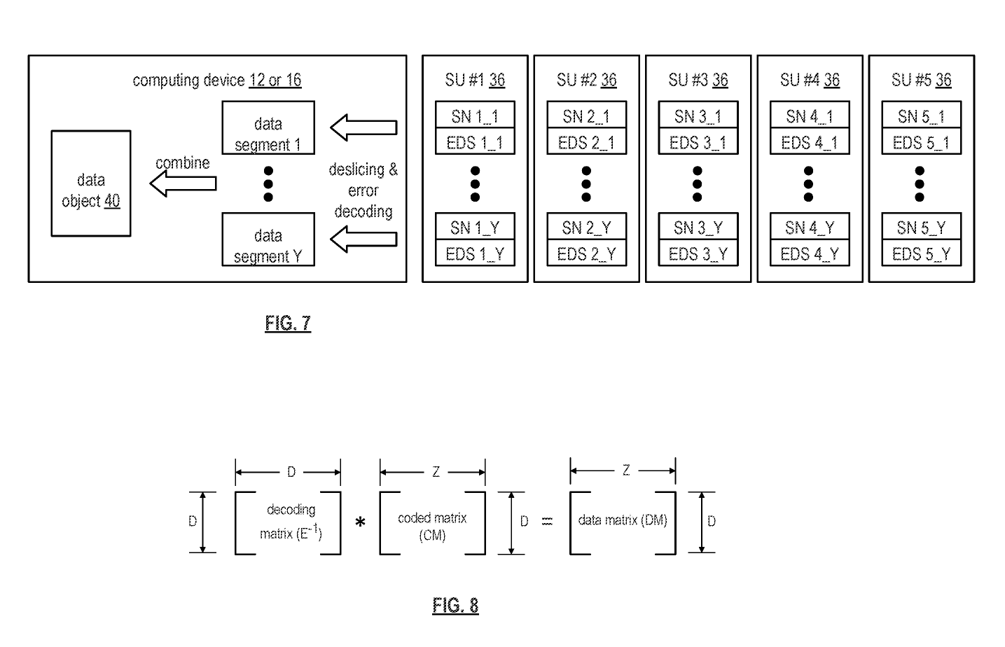

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

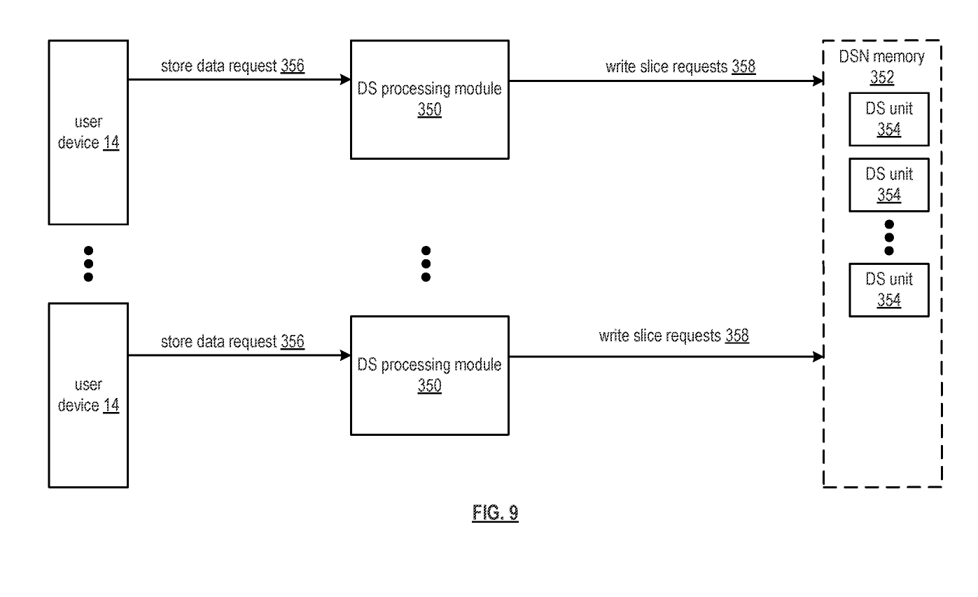

Referring next to FIGS. 9-11, various embodiments that use a namespace to augment de-duplication will be discussed. In various embodiments, a DS processing unit that processes data to be de-duplicated may use elements of the data content to influence the selection of the name for the data source. For example, the hash of the first 100 bytes of the data may be used to select some portion of bits for the name of the file/object. Because the name determines where the slices of the object will reside in the logical namespace, altering the naming of the object stored in a namespace, will in part determine to which ds units the slices will be sent. De-duplication is made more effective when identical data is sent to the same entity to do the comparison of whether or not the data is known. By performing name selection in this way, identical data may, with a very high probability, go to the same ds units, and therefore substantially all de-duplication decisions can be performed locally by that ds unit without having to check if the data exists on other ds units.

Note that, as used herein, a “very high probability” is believed to be greater than about 75%, but the exact probability has not been mathematically proven. The term “very high probability,” in the context of a probability of sending identical data to the same entity for de-duplication comparison, refers to a probability that, at a minimum, is greater than the probability achieved using name assignments that do not take into account the data contents.

FIG. 9 is a schematic block diagram of an embodiment of a dispersed storage system that includes a plurality of user devices 14, such as computing device 12 of FIG. 1, a plurality of dispersed storage (DS) processing modules 350, and a dispersed storage network (DSN) memory 352. The DSN memory 352 includes a plurality of DS units 354. The DS units 354 may be organized into one or more sets of DS units 354. Each DS unit 354 of the one or more sets of DS units may be implemented utilizing one or more of a storage node, a dispersed storage unit, the storage unit 36 of FIG. 1, a storage server, a storage module, a memory device, a memory, a user device, a DST processing unit, such as computing device 16 of FIG. 1, and a DST processing module. Each DS processing module 350 of the plurality of DS processing modules may be implemented by at least one of a server, a computer, a DS unit, a user device, a processing module, a DS processing unit, a DST processing module, and a DST processing unit, such as computing device 16 of FIG. 1.

The system functions to store data in the DSN memory 352 in accordance with a data de-duplication approach. In an example of operation of the data de-duplication approach, a first user device 14 issues a first store data request 356 to a first DS processing module 350 to store data in the DSN memory 352, where the first store data request 356 includes the data and a data identifier (ID) of one or more data IDs associated with the data. As an example of utilization of another data ID, a second user device 14 sends a second store data request 356 to a second DS processing module 350, where the second store data request 356 includes other data (e.g., that is identical to the data from the first user device 14) and another data ID associated with the other data.

Having received the first store data request 356 from the first user device 14, the first DS processing module 350 partitions the data to produce a plurality of data segments in accordance with a data segmentation approach. For a data segment of the plurality of data segments, the first DS processing module 350 encrypts the data segment to produce an encrypted data segment utilizing at least one of convergent encryption or convergent all or nothing transformation (AONT) encryption. Alternatively, or in addition to, the first DS processing module 350 selects one of the convergent encryption and the convergent AONT encryption based on one or more of a security requirement, a retrieval requirement, a performance requirement, a lookup, a query, receiving an indicator, and a predetermination. When utilizing convergent encryption, the first DS processing module 350 applies a deterministic function to the data segment to generate a deterministic key and stores metadata associated with the data segment that includes the deterministic key. The storing may include encrypting the deterministic key using a public key of the first user device 14. The storing may further include storing the metadata in at least one of a local memory of the first DS processing module 350, a local memory of the first user device 14, and in the DSN memory 352 as a set of encoded metadata slices.

When storing the metadata in the DSN memory 352, the first DS processing module 350 encodes the metadata using a dispersed storage error coding function to produce the set of encoded metadata slices, generates a set of slice names associated with metadata of the data ID, generates a set of write slice requests that includes the set of encoded metadata slices and the set of slice names, and outputs the set of write slice requests to the DSN memory 352. When utilizing convergent AONT encryption, the first DS processing module 350 generates a random key, performs a deterministic function on the encrypted data to produce a digest, masks the random key using the digest to produce a masked key, and appends the masked key to the encrypted data to produce a secure package as an updated encrypted data segment.

The first DS processing module 350 generates a data tag based on the data segment. The generating includes at least one of applying a deterministic function to the data segment and applying the deterministic function to the encrypted data segment. The deterministic function may include at least one of a hashing function, a hash-based message authentication code (HMAC) function, a mask generating function (MGF), and a sponge function. The first DS processing module 350 encodes the encrypted data segment using the dispersed storage error coding function to produce a set of encoded data slices. The first DS processing module 350 generates a set of slice names for the set of encoded data slices to correspond to one or more of the data ID, the data tag, a user device ID, and a vault ID associated with the user device. For example, the first DS processing module 350 generates a source name based on a vault ID associated with the user device and generates the set of slice names to include the source name in accordance with dispersed storage error coding parameters. The first DS processing module 350 generates a set of write slice requests 358 that includes the set of encoded data slices, the data tag, and the set of slice names. The first DS processing module 350 outputs the set of write slice requests 358 to a set of DS units 354 of the DSN memory 352.

For each DS unit 354 of the set of DS units 354, the DS unit 354 receives a corresponding write slice request 358 of the set of write slice requests and determines whether a received encoded data slice is duplicated within the DSN memory 352 based on the data tag of the write slice request 358. The determining may be based on one or more of comparing the data tag to a data tag list associated with the DSN memory 352, initiating a query, generating another data tag for an encoded data slice that was not previously associated with a data tag, and receiving a query result.

When the DS unit 354 determines that the encoded data slice is not duplicated within the DSN memory 352, the DS unit 354 stores the encoded data slice locally, stores metadata locally (e.g., including a local storage location associated with storage of the encoded data slice), and updates the data tag list associated with the DSN memory 352 to include a location indicator for the encoded data slice corresponding to the data tag and slice name associated with the encoded data slice. When the DS unit 354 determines that the encoded data slice is duplicated within the DSN memory 352, the DS unit 354 stores the metadata locally, where the metadata includes another storage location associated with storage of another encoded data slice that is a duplicate of the received encoded data slice.

In an example of retrieval of the data, a retrieving user device 14 must have previously stored the data such that metadata is stored associated with a data ID used by the retrieving user device and recovery of the deterministic key requires decrypting the deterministic key recovered from the metadata using a private key associated with the user device. In an example of operation when the retrieving user device has not previously stored the data, the data is only recoverable when the data was stored utilizing the convergent AONT encryption approach since the random key is recovered by de-appending a recovered secure package

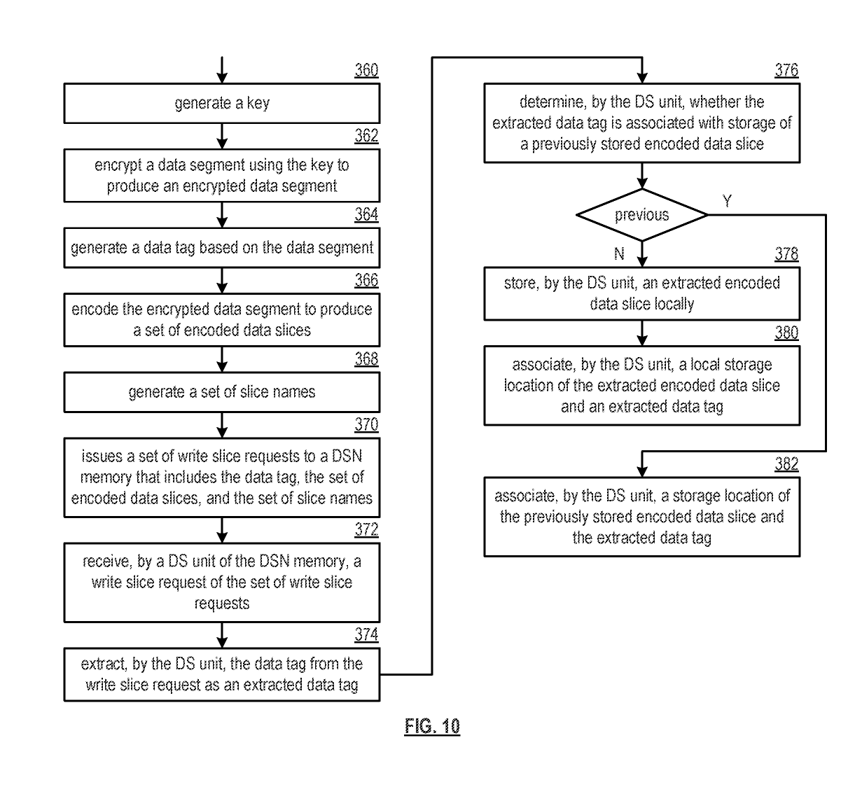

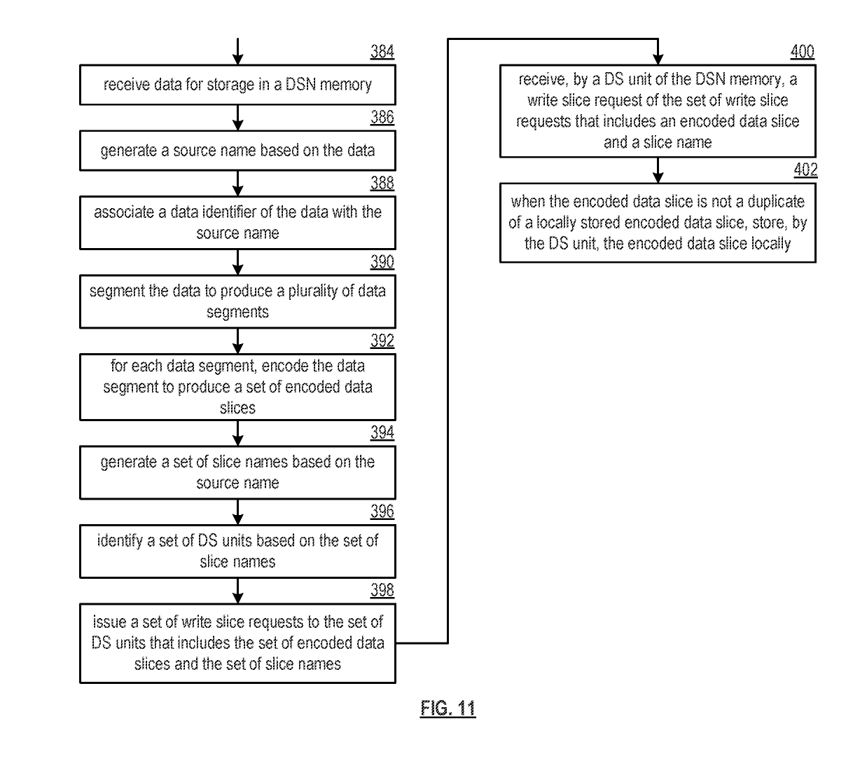

FIG. 10 is a flowchart illustrating an example of storing data. The method begins at step 360 where a processing module (e.g., of a dispersed storage processing module) generates a key. The generating includes at least one of performing a deterministic function on data for storage to produce the key and generating a random key when utilizing an all or nothing transformation (AONT) approach for storing the key in a subsequent step. The method continues at step 362 where the processing module encrypts a data segment of the data using the key to produce an encrypted data segment. The method continues at step 364 where the processing module generates a data tag based on the data segment. The generating includes performing a deterministic function on one or more of the key and the encrypted data segment. The method continues at step 366 where the processing module encodes the encrypted data segment using a dispersed storage error coding function to produce a set of encoded data slices.

The encoding may further include obfuscating the key to produce at least one of an encrypted key and a masked key. When producing the encrypted key, the processing module encrypts the key with a public key associated with a requesting entity to produce the encrypted key. When producing the master key, the processing module performs a deterministic function on the encrypted data segment to produce a digest, masks the key using the digest (e.g., performing an exclusive OR function on the key and the digest) to produce the masked key which is appended to the encrypted data segment. The method continues at step 368 where the processing module generates a set of slice names. The generating may be based on one or more of a data identifier of the data, a vault identifier, a user device identifier, and the data tag.

The method continues at step 370 where the processing module issues a set of write slice requests to a dispersed storage network (DSN) memory that includes the data tag, the set of encoded data slices, and a set of slice names. When not utilizing the AONT approach, the processing module stores the encrypted key in the DSN memory as metadata associated with the data (e.g., issues a set of write slice requests to the DSN memory that includes a set of encrypted key slices generated by encoding the encrypted key using the dispersed storage error coding function).

The method continues at step 372 where a dispersed storage (DS) unit of the DSN memory receives a write slice request of the set of write slice requests. The method continues at step 374 where the DS unit extracts the data tag from the write slice request as an extracted data tag. The method continues at step 376 where the DS unit determines whether the extracted data tag is associated with storage of a previously stored encoded data slice. The determining includes one or more of comparing the extracted data tag to a data tag list, initiating a query, and accessing a hierarchical dispersed index that includes a plurality of data tags associated with a plurality of data IDs and DSN storage location addresses. The method branches to step 382 when the extracted data tag is associated with storage of the previously stored encoded data slice. The method continues to step 378 when the extracted data tag is not associated with storage of the previously stored encoded data slice.

The method continues at step 378 where the DS unit stores an extracted encoded data slice locally when the extracted data tag is not associated with storage of the previously stored encoded data slice. The storing may further include storing metadata associated with the extracted encoded data slice when the metadata is received with the write slice request. The method continues at step 380 where the DS unit associates a local storage location of the extracted encoded data slice and an extracted data tag. The associating includes storing association information locally and outputting the association information to other DS units of the DSN memory. The method continues at step 382 where the DS unit associates a storage location of the previously stored encoded data slice and the extracted data tag when the extracted data tag is associated with storage of the previously stored encoded data slice. The associating includes storing association information locally.

FIG. 11 is a flowchart illustrating another example of storing data. The method begins at step 384 where a processing module (e.g., of a dispersed storage processing module) receives data for storage in a dispersed storage network (DSN) memory. In addition, the processing module may receive one or more of a data identifier of the data, a data size indicator, a data type indicator, a requesting entity identifier, a vault identifier, and a source name associated with the data. The method continues at step 386 where the processing module generates a source name based on the data. The generating includes performing a deterministic function on a portion of the data to produce an object number utilized within an object number field of the source name. The source name includes the object number field, a vault ID field, and a generation field. The method continues at step 388 where the processing module associates the data identifier of the data with the source name. The associating includes updating one or more of an entry of a dispersed hierarchical index, a directory, and a list, to include the source name and the data ID. The dispersed hierarchical index includes a plurality of index nodes arranged in a virtual pyramid from a root node down to leaf nodes, where each node includes links to neighboring nodes and an index key value utilized when searching the dispersed hierarchical index for a particular entry. The leaf nodes include one or more DSN addresses (e.g., source names, slice names) of data objects stored in the DSN memory.

The method continues at step 390 where the processing module divides the data to produce a plurality of data segments in accordance with a data segmentation approach (e.g., fixed segment size, verbal segment sizes). The method continues at step 392 where the processing module, for each data segment, encodes the data segment using a dispersed storage error coding function to produce a set of encoded data slices.

The method continues at step 394 where the processing module generates a set of slice names based on the source name and a segment number of the data segment, where each slice name includes a corresponding pillar index field entry, the source name, and the segment number. The method continues at step 396 where the processing module identifies a set of dispersed storage (DS) units based on the set of slice names. The identifying includes at least one of a lookup based on a slice name address range of the set of slices, a query, and receiving DS unit identity information. The method continues at step 398 where the processing module issues a set of write slice requests to the set of DS units that includes the set of encoded data slices in the set of slice names. The issuing includes generating the set of write slice requests and outputting the set of write slice requests to the set of DS units.

The method continues at step 400 where a DS unit of the DSN memory receives a write slice request of the set of write slice requests that includes an encoded data slice and a slice name. When the encoded data slice is not a duplicate of a locally stored encoded data slice, the method continues at step 402 where the DS unit stores the encoded data slice locally. The storing includes determining whether the encoded data slice is substantially the same as a locally stored encoded data slice (e.g., referencing a list, performing a comparison, initiating a query, receiving the response). The storing further includes storing metadata associated with the encoded data slice when the metadata is received and storing a slice name and a local storage location associated with storage of the encoded data slice.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for use in a distributed storage network (DSN), the method comprising:
receiving data to be de-duplicated for storage in a DSN memory;
generating a source name associated with the data, the source name based on contents of the data to be stored;
generating encoded data slices from the data, the encoded data slices having slice names assigned based on the source name associated with the data being encoded;
assigning selected distributed storage (DS) units to de-duplicate and store the encoded data slices, wherein DS units are selected based on the slice names of the encoded data slices; and
transmitting the encoded data slices to the selected DS units for de-duplication and storage of de-duplicated encoded data slices.

2. The method of claim 1, further comprising:
associating a data identifier of the data with the source name.

3. The method of claim 1, further comprising:
segmenting the data to produce a plurality of data segments;
encoding each of the plurality of data segments to generate a set of encoded data slices, wherein at least a read-threshold number of encoded data slices included in the set of encoded data slices is required to reconstruct the data;
generating a set of slice names to assign to each of the encoded data slices included in the set of encoded data slices; and
issuing a set of write slice requests to the selected DS units, the set of write slice requests including the set of encoded data slices, and the set of slice names.

4. The method of claim 3, further comprising
receiving, by a selected DS unit of the DSN memory, a write slice request of the set of write slice requests, the write slice request including a first encoded data slice and a slice name.

5. The method of claim 4, further comprising:
determining whether the first encoded data slice is a duplicate of a second encoded data slice already stored by the selected DS unit.

6. The method of claim 5, further comprising:
in response to determining that the first encoded data slice is not a duplicate of a second encoded data slice already stored by the selected DS unit, storing the first encoded data slice in the selected DS unit.

7. The method of claim 1, wherein:
each slice name includes a corresponding pillar index field entry, the source name, and a segment number.

8. A distributed storage network (DSN) comprising:
a distributed storage (DS) processing module including a processor and associated memory;
a DSN memory coupled to the DS processing module, the DSN memory including a processor and associated memory, and further including a plurality of DS units;
the DS processing module configured to:
receive data to be de-duplicated for storage in the DSN memory;
generate a source name associated with the data, the source name based on contents of the data to be stored;
generate encoded data slices from the data, the encoded data slices having slice names assigned based on the source name associated with the data being encoded;
assign selected DS units to de-duplicate and store the encoded data slices, wherein DS units are selected based on the slice names of the encoded data slices; and
transmit the encoded data slices to the selected DS units for de-duplication and storage of de-duplicated encoded data slices.

9. The distributed storage network (DSN) of claim 8, wherein the DS processing module is further configured to:
associate a data identifier of the data with the source name.

10. The distributed storage network (DSN) of claim 8, wherein the DS processing module is further configured to:
segment the data to produce a plurality of data segments;
encode each of the plurality of data segments to generate a set of encoded data slices, wherein at least a read-threshold number of encoded data slices included in the set of encoded data slices is required to reconstruct the data;
generate a set of slice names to assign to each of the encoded data slices included in the set of encoded data slices; and
issue a set of write slice requests to the selected DS units, the set of write slice requests including the set of encoded data slices, and the set of slice names.

11. The distributed storage network (DSN) of claim 10, wherein the DSN memory is configured to:
receive, at a selected DS unit of the DSN memory, a write slice request of the set of write slice requests, the write slice request including a first encoded data slice and a slice name.

12. The distributed storage network (DSN) of claim 11, wherein the DSN memory is further configured to:
determine whether the first encoded data slice is a duplicate of a second encoded data slice already stored by the selected DS unit.

13. The distributed storage network (DSN) of claim 12, wherein the DSN memory is further configured to:
in response to determining that the first encoded data slice is not a duplicate of a second encoded data slice already stored by the selected DS unit, storing the first encoded data slice in the selected DS unit.

14. The distributed storage network (DSN) of claim 8, wherein:
each slice name includes a corresponding pillar index field entry, the source name, and a segment number.

15. A distributed storage (DS) processing module comprising:
a processor;
memory coupled to the processor;
the processor configured to:
receive data to be de-duplicated for storage in a distributed storage network (DSN) memory, the DSN memory including a plurality of DS units configured to store encoded data slices;
generate a source name associated with the data, the source name based on contents of the data to be stored;
generate encoded data slices from the data, the encoded data slices having slice names assigned based on the source name associated with the data being encoded;
assign selected DS units to de-duplicate and store the encoded data slices, wherein DS units are selected based on the slice names of the encoded data slices; and
transmit the encoded data slices to the selected DS units for de-duplication and storage of de-duplicated encoded data slices.

16. The distributed storage (DS) processing module of claim 15, wherein the processor is further configured to:
associate a data identifier of the data with the source name.

17. The distributed storage (DS) processing module of claim 16, wherein the processor is further configured to:
associate the data identifier with the source name by updating a directory.

18. The distributed storage (DS) processing module of claim 15, wherein the processor is further configured to:
segment the data to produce a plurality of data segments;
encode each of the plurality of data segments to generate a set of encoded data slices, wherein at least a read-threshold number of encoded data slices included in the set of encoded data slices is required to reconstruct the data;
generate a set of slice names to assign to each of the encoded data slices included in the set of encoded data slices; and
issue a set of write slice requests to the selected DS units, the set of write slice requests including the set of encoded data slices, and the set of slice names.

19. The distributed storage (DS) processing module of claim 18, wherein:
a write slice request of the set of write slice requests includes a first encoded data slice and a slice name.

20. The distributed storage (DS) processing module of claim 15, wherein:
each slice name includes a corresponding pillar index field entry, the source name, and a segment number.
